(19) United States
(12) Patent Application Publication
(10) Pub. No.: US 2008/0244446 A1
(43) Pub. Date: Oct. 2, 2008

(54) DISAMBIGUATION OF ICONS AND OTHER MEDIA IN TEXT-BASED APPLICATIONS

(76) Inventors: John LeFevre, Seattle, WA (US); Pim van Meurs, Kenmore, WA (US)

Correspondence Address: PERKINS COIE LLP;PATENT-SEA, P.O. BOX 1247, SEATTLE, WA, 98111-1247, US

(21) Appl. No.: 11/693,620

(22) Filed: Mar. 29, 2007

(51) Int. Cl. G06F 3/048

(52) U.S. Cl. 715/810

(57) ABSTRACT

A system and method for entering icons and other pieces of media through an ambiguous text entry interface. The system receives text entry from users, disambiguates the text entry, and presents the user with a pick list of icons, emoticons, graphics, images, sounds, videos or other non-textual media that are associated with the text entry. The user may select one of the displayed pieces of media, and the text entry may be replaced or supplemented with the piece of media selected by the user. In some cases, the system presents the pick list of media to the user in an order that is related to the probability that the user will select the displayed media.

### CROSS-REFERENCE TO RELATED APPLICATION(S)

This application is related to commonly assigned U.S. Pat. No. 6,307,549, entitled REDUCED KEYBOARD DISAMBIGUATION SYSTEM, incorporated by reference herein.

### BACKGROUND

People increasingly are using mobile devices, such as cell phones, to input and send text-based communications to one another. For example, people write text messages, instant messages, and emails with these devices and use them as forms of inter-personal communication. Unfortunately, the input of text using hand-held and other mobile or personal devices is often hampered by the number of keys on a device's keypad. Keypads on a mobile device typically have fewer keys than the number of letters, punctuation symbols, and other characters that need to be entered by a user. As a result, various systems have been developed to simplify the entry of text with reduced keyboards. For example, disambiguation systems such as the T9 system developed by Tegic Communications, Inc., of Seattle, Wash., delimit text sequences received from reduced keyboards to match the sequence (or partial sequence) with words having the same letter sequences. For example, when a user enters “7-2-6” the systems may present the words “ram” or “pan.”

While disambiguation systems work particularly well for the entry of text, users often wish to include other types of information in messages, including icons, images, sounds, or other media. Current systems are not well suited for the entry of such media. For example, users of mobile devices may desire to send an emoticon, such as a graphical smiley face [symbol] that corresponds to a character sequence of “:” followed by a “),” or :). Many systems having reduced keyboards receive the entry of punctuation via the “1” key on the reduced keyboard. In order for a user to enter the :) emoticon, he/she must press the “1” key numerous times until the “:” appears, wait a few seconds for a cursor to move to the next space in a sequence, and press the “1” key again until the “)” appears. Entering an emoticon in a text message or other text-based sequence with a mobile device is therefore a labor intensive process that requires numerous key presses by the user.

Current systems are also not well suited for the entry of media because of the number of different icons and other media that a user may desire to insert into a message. There may be thousands, if not millions, of different pieces of media (icons, graphics, and so on) that a user may wish to place into a message. Developing keystroke paths to each piece of media that are memorable and easy to use is a challenging problem. Current systems have therefore typically limited the number and type of media that a user may insert into a text-based communication.

These and other problems exist with respect to the entry of icons or other media in mobile devices and other devices, such as devices with reduced keyboards.

### BRIEF DESCRIPTION OF THE DRAWINGS

FIG. 1 is a block diagram illustrating an example mobile device on which media disambiguation methods may be implemented.

FIG. 2 is a flow diagram illustrating an example routine for identifying a piece of media associated with a text string.

FIG. 3 is a flow diagram illustrating an example routine for displaying a selected piece of media in a text-based message.

FIGS. 4A-4B are diagrams showing example user interface screens displaying a list of disambiguated media.

FIGS. 5A-5E are diagrams showing example user interface screens displaying the construction of an iconic sequence.

### DETAILED DESCRIPTION

A system and method for entering icons and other pieces of media (collectively “media”) through an ambiguous text entry interface is disclosed. The system receives text entry from users, disambiguates the text entry, and presents the user with icons, emoticons, graphics (including graphics of text and other characters), images, sounds, videos or other non-textual media that are associated with the text entry. For example, as a user enters the sequence “I wish you a happy birthday” the system generates a pick list or other displayable menu to a user upon disambiguating the word “birthday” or a partial form of birthday (such as “b-i-r-t-h-d” from an entered key string “2-4-7-8-4-3”). In this example, the system may display a list of media, such as a cake with candles, a face with a birthday cap, a representation of a song clip of “happy birthday,” a video of candles being blown out, or any other piece of media deemed to be associated with a birthday. The user may select one of the displayed pieces of media, and the word “birthday” may be replaced or supplemented with the piece of media selected by the user.

In some cases, the system presents the pick list of media to the user in an order that is related to the probability that the user will select the displayed media. Those pieces of media that are most likely to be selected are listed first, and those pieces of media that are least likely to be selected are listed last. As the user selects various pieces of media, the ordering of the pieces of media may be modified to reflect the personal preferences of the user.

In some cases, the system builds a sequence of icons to represent a text sequence. For example, for each word, partial word, or separated character sequence received from a user during text entry, the system may display a pick list of related icons (or icon) for selection by a user, and replace the words with the icons selected by the user. Thus, the system may associate icons from text entries to build iconic sequences.

It will be appreciated that two stages of disambiguation may therefore be performed before a piece of media is inserted into a text communication of a user. In a first stage, the keystrokes or other input by the user is disambiguated in order to identify the most likely textual string that is associated with the input. In a second stage, the textual string is disambiguated in order to identify the most likely piece or pieces of media that would be associated with the identified textual string.

The technology will now be described with respect to various embodiments and examples. The following description provides specific details for a thorough understanding of, and enabling description for, these embodiments of the technology. However, one skilled in the art will understand that the technology may be practiced without many of these details. In other instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section. The headings provided herein are for convenience only and do not necessarily affect the scope or meaning of the claimed technology.

### Suitable Devices

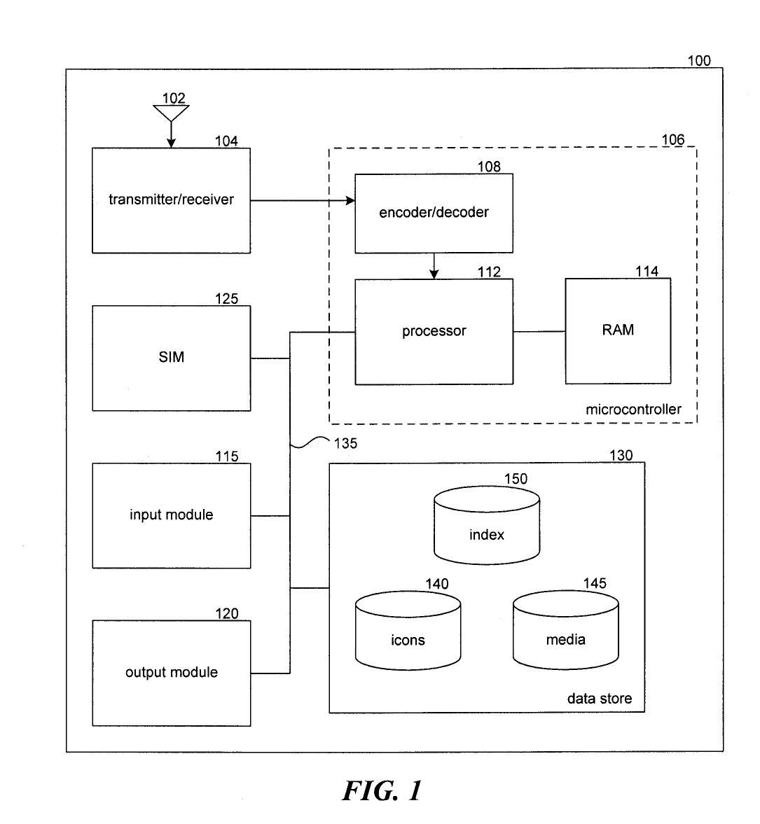

Referring to FIG. 1, a representative device 100 on which a media disambiguation system may be implemented is described. The device 100 may be, for example, a mobile or hand-held device such as a cell phone, mobile phone, mobile handset, and so on. The device may also be any other device with a reduced input user interface, such as an electronic media player, a digital camera, a personal digital assistant, and so on.

The device 100 may include a transmitter/receiver 104 to send and receive wireless messages via an antenna 102. The transmitter/receiver is coupled to a microcontroller 106, which consists of an encoder/decoder 108, a processor 112, and RAM (Random Access Memory) 114. The encoder/decoder 108 translates signals into meaningful data and provides decoded data to the processor 112 or encoded data to the transmitter/receiver 104. The processor is coupled to an input module 115, an output module 120, a subscriber identify module (SIM) 125, and a data storage area 130 via a bus 135. The input module 110 receives input representing text characters from a user and provides the input to the processor 112. The input module may be a reduced keypad, i.e., a keypad wherein certain keys in the keypad represent multiple letters such as a phone keypad. With a reduced keypad, depressing each key on the keypad once results in an ambiguous text string that must be disambiguated. The input module may alternatively be a scroll wheel, touch screen or touch pad (implementing, for example, a soft keyboard or hand-writing recognition region), or any other input mechanism that allows the user to specify a string of one or more characters requiring disambiguation. The output module 140 acts as an interface to provide textual, audio, or video information to the user. The output module may comprise a speaker, an LCD display, an OLED display, and so on. The device may also include a SIM 125, which contains user-specific data.

Data and applications software for the device 100 may be stored in data storage area 130. Specifically, one or more software applications are provided to implement the media disambiguation system and method described herein. Data storage area 116 may include an icon database 140 that store icons, and a media database 145 that stores other media. Data storage area also includes an index 150 that stores a correlation between a received text string and one or more icons or media that are associated with that text string. The correlation between text string and one or more icons or media may be generated by a population of users tagging icons or media with appropriate text strings, by a service that manually or automatically interprets icons or media and applies appropriate text strings, or by other methods such as those described in U.S. patent application Ser. No. 11/609,697 entitled “Mobile Device Retrieval and Navigation” (filed 12 Dec. 2006), incorporated by reference herein. The index may be structured so that the icons or media are listed in an order that is correlated with the likelihood that the icon or media will be selected by the user. In some embodiments, the index may take a similar form to the vocabulary modules described in U.S. Pat. No. 6,307,549, entitled REDUCED KEYBOARD DISAMBIGUATION SYSTEM, incorporated by reference herein. The icon database, media database, and index may be pre-installed on the device 100, may be periodically uploaded in part or whole to the device, or may be generated and/or expanded by the device user. That is, a user may add icons and other media to the databases and manually or automatically associate the icons and other media with appropriate text strings. Allowing the user to build the database and index ensures that the displayed icons and other media will be those that the user finds most beneficial.

As will be described in additional detail herein, the input module 114 receives a text string from a user. The media disambiguation system uses the index 150 to identify one or more icons or pieces of media from the databases 140 and 145 that are associated with the text string. For example, if the system receives input data related to the text sequence “heart”, a heart icon may be identified in the icon database 140 and an interactive heart graphic and heart beat audio tone may be identified in the media database 145. Once identified, the system outputs some or all icons or media to the user via the output module 120. For example, a menu or other pick list of received icons or media may be displayed to the user via a graphical user interface. The system then allows the user to select which piece of media to use in a text communication.

FIG. 1 and the discussion herein provide a brief, general description of a suitable device in which the media disambiguation system can be implemented. One skilled in the relevant art can readily make modifications necessary to the blocks of FIG. 1 based on the detailed description provided herein. Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a wired or wireless communications network, such as a Local Area Network (LAN), Wide Area Network (WAN), or the Internet. In a distributed computing environment, program modules may be located in both local and remote memory storage devices. For example, the index 150, icon database 140, and media database 145 may be stored remotely from the device.

### Media Disambiguation

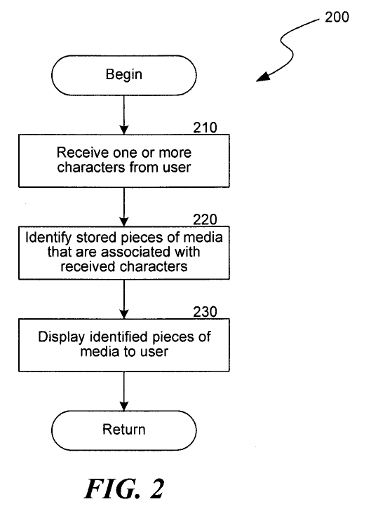

Referring to FIG. 2, a flow diagram illustrating an example routine 200 for identifying a piece of media that is associated with received text is described. FIG. 2 and other flow diagrams described herein do not show all functions or exchanges of data, but instead they provide an understanding of commands and data exchanged under the system. Those skilled in the relevant art will recognize that some functions or exchanges of commands and data may be repeated, varied, omitted, or supplemented, and other aspects not shown may be readily implemented.

In step 210, the system receives text input from a keypad or other input module. For example, a user utilizing a text messaging application on his/her mobile device may begin to enter a text sequence via the numeric keypad of the mobile device. The user may enter the text sequence by pressing an individual key multiple times to find a letter or character. The user may also enter the text sequence via a text disambiguation application, such as T9 described herein, where keys are pressed and words are identified based on disambiguation techniques.

In step 220, the system matches the received text from the user with one or more icons or other media stored in a database, such as icon database 145 or media database 150. The system may match the received text to a single icon or piece of media, to multiple icons or pieces of media, or the system may not retrieve a matched icon or piece of media. For example, the system may match the word “kiss” with one or more of an icon of lips, an icon of two figures kissing, a sound of a kiss, a moving image (such as a moving image of two people kissing), a stored graphic or picture (such as a photo of a user and his/her significant other kissing), a music video of the rock band Kiss, and so on.

The received text that is matched by the system to an icon or media may correspond to a phrase, a word, or a character fragment comprising part of a word. For example, the system may receive a sequence of “B-O-” and match the sequence with icons or media related to boats (boat), bones (bone), boys (boy), robots (robot), and so on. Thus, the system may match defined sequences, partial sequences, unambiguous sequences, ambiguous sequences and so on with different and unique icons and other media.

In some cases, the system may wait to start the matching process until after a user has completed his or her text entry. For example, the system may receive an entered sequence of “Would you like to eat later?” from a user. The system may be configured to start the media matching process after punctuation indicating the end of a sentence has been detected (e.g., a period, question mark, exclamation mark), or the system may receive a manual indication from the user to provide matching pieces of media where available or appropriate. In the above example, the system may therefore determine that the word “eat” matches a number of stored pieces of media, and inform the user of the match. In other cases, rather than wait until after a user has completed text entry, the system may match received text as the user enters the text. In these cases, the system provides media matches for each partial and full word as the user enters each character.

In some cases, the system may determine a concept related to the content of entered text, and relate icons and other media to the concept. For example, the user may enter the word “kiss” and the system may present the user with a picture of a heart.

In some cases, the databases that the system accesses to retrieve pieces of media may not be stored locally to the device. In these cases, the system would make a request to a remote service accessed over a network (such as the Internet) to receive media that matches the received text string. The remote service would match the text string to one or more databases and return one or more pieces of media to the system.

In step 230, the system displays icons and other pieces of media to the user that match or are related to the received text. For example, the system may display a pick list to a user via the display on the mobile device. The pick list may contain one or more of the identified icons and pieces of media that are related to the received text. The items in the pick list may be ordered based on a variety of different factors, such as based on a determined likelihood of accuracy in disambiguation, based on historical information related to previous icon or media choices by the user or by a group of users, based on the context in which the text was received such as the surrounding text entered by the user, based on a frequency of occurrence of an icon or media when following or preceding a linguistic object or linguistic objects, based on the proper or common grammar of the surrounding text, and based on known information about the user such as the location of the user, the sex of the user, or the various interests of the user. Moreover, the system may include in the list a variety of different media types or formats. For example, the system may display a pick list having as a first entry a word that matches or is related to the received text, as a second entry an icon related to the received text, as a third entry an indication of a sound or moving graphic related to the received text (e.g., a link or other pointer to the associated media), and as a fourth entry an option to view additional choices. The pick list may be conveyed to the user in a variety of different formats, including via one or more menus, lists, separate or overlaid screens, audio tones or other output, and so on.

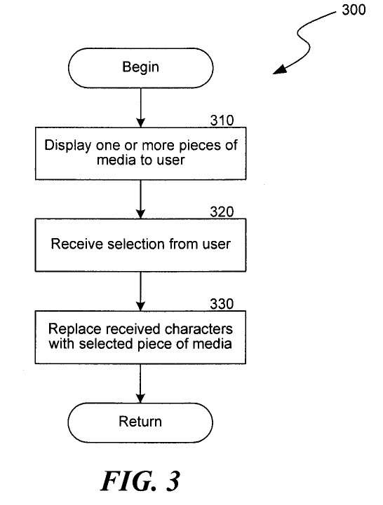

Referring to FIG. 3, a flow diagram illustrating an example routine 300 for displaying selected media in a text-based message is described. In step 310, the system displays a pick list containing matched media or a matched piece of media to a user. For example, the system may display a list of icons related to a partial form of a word in a user-entered text sequence within a text messaging application. The icons may be different representations of an icon that is related to the entered word (such as three different graphical depictions of a heart for the word “heart”). The icons may also be different icons that are each related to different words (such as icons for a house and a hound for the partially entered sequence of “hou”).

In step 320, the system receives a selection of a piece of media from the user. For example, the system displays a pick list and receives a selection of one of the items in the list. The system may enable the user to scroll and select from the pick list via one or more keys on the keypad, via other control keys, via soft keys within the displayed list, via audio input, and so on.

The system may modify or otherwise rearrange or manipulate the pick list in order to facilitate a user's selection of an item in the list. In some cases, user displays are small or of low quality, and displayed icons and other media may be difficult to decipher. The system may therefore enlarge one or more items in the list for a user. For example, as a user scrolls a pick list, the system may provide an enlargement of each item in the list as the user examines each item. The system may also enhance the graphic or quality of an item as the user selects or scrolls to the item in the pick list. For example, the system may normally provide a low quality display of all the items in the list, and enhance an item in the pick list (such as by enhancing the colors, resolution, and so on), when a user moves a cursor to the icon. The system may, for certain types of media items, selectively display or play the media when a user moves a cursor to the item in the list. For example, the system may provide a pick list that includes an icon that includes or is related to an audio segment. Once a user selects the icon with the accompanying audio segment, the system may play the audio segment. Other modifications to the display of pick lists are of course possible.

In step 330, the system places a selected piece of media, or a representation of a selected piece of media, in the character sequence. For example, when a user selects an item from a displayed list, the system places the selected piece of media into the text sequence that is displayed to the user. The piece of media may replace the text that was entered by the user which led to the identification of the piece of media. For example, the text “smi” might be replaced by the emoticon “ [symbol] ” for “smile.” Alternatively, the piece of media may merely supplement the text that was entered by the user. For example, the piece of media may be placed immediately following the text such as in “smile [symbol] .” When sounds or videos are placed into the displayed character sequence, a link or other pointer to the sound or video may be inserted by the system into the sequence.

In some cases, the system may automatically replace one or a select number of words or character sequences (such as emoticon representations) in a text sequence. For example, using the disambiguation methods described herein, the system may display a user entered sequence of “I love you :)” as “I [symbol] you [symbol] ”. In some cases, the system may replace an entire text sequence with an iconic or other media sequence. For example, using the disambiguation methods described herein, the system may replace a user-entered sequence of “I miss you” with an icon of a person crying followed by an icon of an airplane.

It will be appreciated that the system provides a user with many different ways to intimate a feeling, emotion, or other message using icons and other media without forcing the user to spend a significant amount of time searching through lists of media in order to identify the desired media to add to the communication.

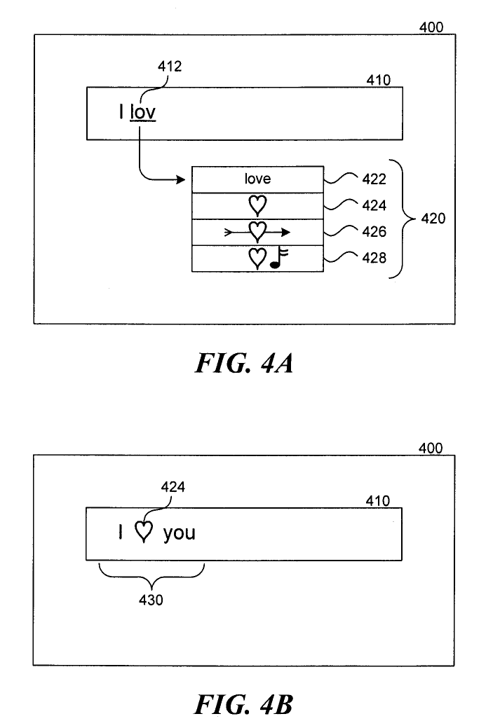

FIGS. 4A-4B are diagrams showing example user interface screens 400 displaying a pick list of pieces of media. The user interface provides facilities to receive input data, such as a form with field(s) to be filled in, pull-down menus allowing one or more of several options to be selected, buttons, sliders, hypertext links or other known user interface features for receiving user input. While certain ways of displaying information to users is shown and described with respect to the user interface, those skilled in the relevant art will recognize that various other alternatives may be employed.

The screens may be stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), Flash format, or matrix or bit-mapped formats.

FIG. 4A illustrates a screen 400, such as a user interface display on a mobile device. Screen 400 includes an input entry field 410, such as a text entry field within a text messaging or instant messaging application of a mobile phone. During entry of characters, the system may display a pick list 420 or other menu when the system matches a user input sequence of characters 412 with one or more icons or other pieces of media stored in local or remote databases. For example, in FIG. 4A, the text sequence of “5-6-8” matches a number of different representations, including a textual representation 422 of “love” (disambiguated using a text disambiguation system, such as the T9 system), a first iconic representation 424, a second iconic representation 426, and a combination image and audio representation 428.

When a pick list 420 is displayed, the system allows the user to select one or more items in the pick list. The selection may be made by the user by moving a cursor over the item and pressing an “enter” or “select” key, by selecting a particular function key that is tied to a particular item in the list (e.g., a first function key tied to the first item, a second function key tied to the second item), or by any other selection method.

FIG. 4B illustrates display 400 after a user has selected an item in the pick list and the system has replaced a word or portion of a word in an entered text sequence with the selected item. In this example, a user selects representation 424, an icon of a heart related to the character sequence “lov” 412, and the system replaces the entered sequence 412 with the selected icon 424. The user finishes the entry of text, and a finished iconic text message 130 of “I ♡ you” is displayed in screen 400. The user may then send the message to another user, may save the message for later editing or transmission, and so on.

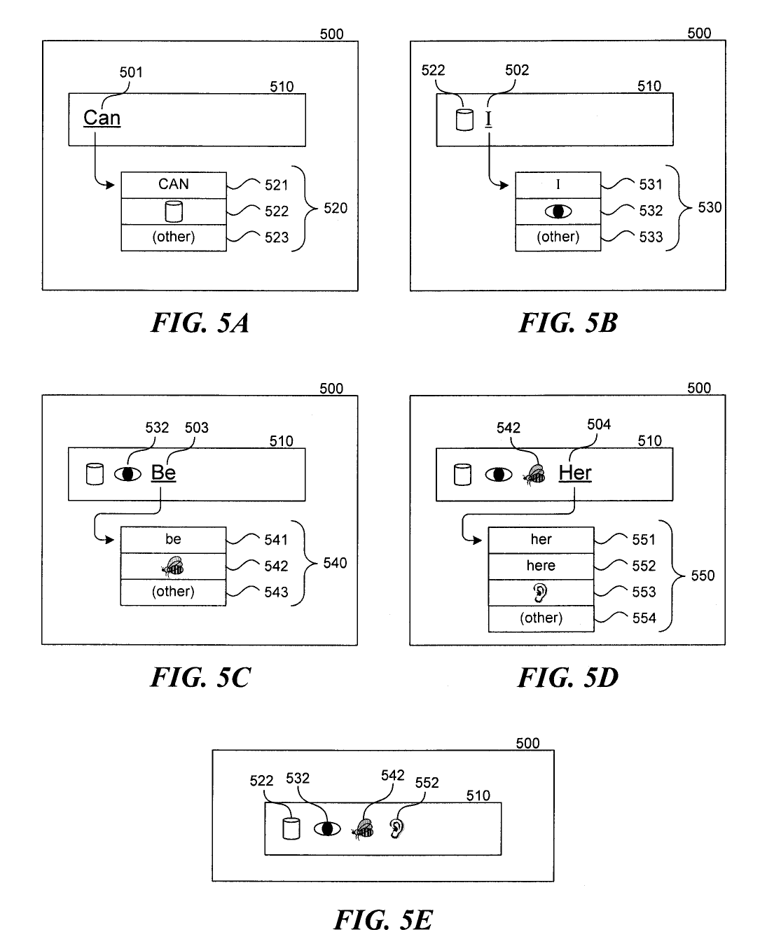

Referring to FIGS. 5A-5E, diagrams showing example user interfaces displaying the construction of an iconic sequence are shown. In FIG. 5A, a screen 500 displaying an initial entry sequence 501 via a character entry field 510 is shown. For example, the system receives a first entered word of “Can” 501, and displays a pick list 520 of related representations, such as a text representation 521, an iconic representation 522, and a place holder or other representation 523 indicating additional or alternative representations for “Can” 501.

In FIG. 5B, the character entry field 510 displays a user-selected icon 522 from the pick list 520 shown in FIG. 5A. Screen 500 also displays a second entered word of “I” 502, as well as a pick list 530 of related representations, such as a text representation 531, an iconic representation 532, and a place holder or other representation 533 indicating additional or alternative representations for “I” 502.

In FIG. 5C, the character entry field 510 displays a user-selected icon 532 from the pick list 530 shown in FIG. 5B. Screen 500 also displays a third entered word of “Be” 503, as well as a pick list 540 of related representations, such as a text representation 541, an iconic representation 542, and a place holder or other representation 543 indicating additional or alternative representations for “Be” 503.

In FIG. 5D, the character entry field 510 displays a user-selected icon 542 from the pick list 540 shown in FIG. 5C. Screen 500 also displays a fourth entered word of “Here” 504, as well as a pick list 550 of related representations, such as a text representation 551, an iconic representation 552, and a place holder or other representation 553 indicating additional or alternative representations for “Here” 503.

In FIG. 5E, the character entry field 510 displays a replaced text sequence with the user-selected icons 522, 532, 542, and 552. Thus, the system may replace or transform text sequences into iconic sequences using the disambiguation methods described herein, providing users a rich variety and large number of icons and other media to use in text-based messaging applications.

In some cases, the system may facilitate communication between users of different native languages, or between a user with a fluent grasp of a language and a user having a partial grasp of the language. Icons are generally universal, and have similar meanings to users viewing the icons. Communicating, or partially communicating, in iconic sequences created by the disambiguation techniques described herein may enable users to reach a larger number of people. The system may also use iconic messages as an intermediate representation of a message between two languages. For example, a user that speaks English may send an English text created iconic message to a user that speaks Dutch. The system may receive the message at the Dutch user's device and convert the message to Dutch. For example, the system may receive a text sequence of “horse,” match “horse” with an icon of a horse, receive an indication from the user to replace the word “horse” with the icon, send the message to the Dutch user, convert the horse icon to “paard” (the Dutch word for horse) and display the message to the Dutch user. Other uses are of course possible.

### Using Context and Other Information in Selecting Pieces of Media

The system may use context (e.g., surrounding words, concepts, or grammar; the current applet being used to compose/send the message; the applet/action immediately preceding the composition of the message; the time of day; the ambient noise or temperature) or other information, such as historical, preference, or user information (e.g., the user's physical location), in deciding what icons or media to display to users. The system may use words of an entered text sequence to understand the context of the user's communication when relating media to character sequences. For example, a user may enter the phrase “Please meet me at the game at 5 P.M.” The system may review the entered phrase and determine that the word “game” matches a number of different stored icons, such icons for baseball team logos (such as a Mets logo), an icon for a board game piece (e.g., a chess piece), or an icon for dice. The system may review the entered phrase and determine that the words “meet” and “5 P.M.” are temporal indicators. Thus, the system may determine that the board game piece and the dice are inappropriate based on the context of the entered sequence, and display icons for different team logos. In another example, the system may receive an entered partial phrase of “how much ca” and determine that icons related to the word “cash” are likely to be intended for the partial phrase of ‘C-A” given the context created by the words “how much.”

The system may also determine appropriate media based on historical user information, the user's preferences, or other information about the user. The system may maintain a database of user selections of media in previous instances, and review the database when determining media to display. Media that the user had frequently selected would be displayed to the user in a pick list before media that the user had infrequently or never selected. The system may also look at user preferences in selecting media. For example, the user may indicate that whenever the user enters “team” they would like the word “team” to be replaced with the Mets logo. The system may also look at other information about the user to aid in media selection, such as the contacts of a user, geographical information associated with the user (either manually input by the user or automatically derived by the user device), and so on.

The system may also look at recently sent or received messages, and media within such messages. For example, a user may be chatting with another user via an instant messaging application. One user may send a message containing an icon for a school, originally entered as “school.” The other user may reply and also enter the word “school.” The system may review the previously received message by the user and determine the user wishes to enter the same icon. Thus, the system may use relational or temporal context when matching media to entered characters.

### Other Considerations

In some cases, the system may disambiguate text input and retrieve user-entered or user-created images. The system may relate received text to user-created photos, user-created icons, user-created audio tones, and so on. The system may enable users to tag such images and representations with words, phrases, and so on. For example, a user may tag a photo of his/her dog with the word “dog,” “hound,” the dog's name, and so on. Thus, the system may retrieve the tagged photo, along with other dog icons, when the user enters “dog” during text entry

In some cases, the system may provide an iconic message and make a translation readily available to a user. For example, the system may store the originally entered message and send both the iconic message and the original text. The system may then provide the receiving user with an option to see the original message, in case the user does not understand some or all of the icons in the received message.

In some cases, the system may provide a certain library of media to a user, and sell or otherwise provide additional media and libraries of media to users. For example, subscribers may receive a select number of media, and purchase more for a nominal fee or receive a library for free when upgrading their mobile service plan.

In some cases, the system described herein may merge with or otherwise collaborate with other disambiguation systems, including the T9 disambiguation system. For example, the system may present a list of media (using methods described herein) together with disambiguated text strings, such as words (using text disambiguation methods).

In some cases, the system may allow the user to associate text with icons and other media and share the created text/media association with other users. For example, a Canadian user may associate the word “tuque” with an icon of a hat and share the icon/text association with other users. The other users may choose to use the provided association, or may assign a different text string such as “beanie” to use with the icon.

### Conclusion

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While various embodiments are described in terms of the environment described above, those skilled in the art will appreciate that various changes to the facility may be made without departing from the scope of the invention. For example, icon database 140, media database 145, and index 150 are all indicated as being contained in a general data store area 130. Those skilled in the art will appreciate that the actual implementation of the data storage area 130 may take a variety of forms, and the term “database” is used herein in the generic sense to refer to any data stored in a structured fashion that allows data to be accessed, such as by using tables, linked lists, arrays, etc.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the invention is not limited except as by the appended claims.

We claim:

1. A system for modifying a character string entered by a user on a device having a reduced keyboard, the system comprising:
an input component that receives one or more characters from a user via a reduced keyboard;
a matching component that identifies one or more pieces of media that are associated with the one or more received characters;
a display component that displays a representation of at least one of the identified one or more pieces of media to the user; and
a selection component that allows a user to select a piece of media from the displayed media, wherein the one or more received characters are replaced by the selected piece of media.

2. The system of claim 1, wherein the one or more characters comprise a word and the one or more pieces of media relate to the word.

3. The system of claim 1, wherein the one or more characters comprise a phrase of two or more words and the one or more pieces of media relate to the phrase.

4. The system of claim 1, wherein the one or more characters comprise a character string and the one or more pieces of media relate to words containing the character string.

5. The system of claim 4, wherein the character string relates to an emoticon and the one or more pieces of media are emoticons.

6. The system of claim 1, wherein the one or more pieces of media are stored in a memory of the device.

7. The system of claim 1, wherein the one or more pieces of media are stored in a data storage area in communication over a network with the device.

8. The system of claim 1, wherein the selected piece of media is used in place of the one or more received characters in a message created by the user.

9. The system of claim 1, wherein the matching component utilizes information pertaining to the context in which the one or more characters were received at least in part to identify the one or more pieces of media that are associated with the one or more received characters.

10. The system of claim 1, wherein the matching component utilizes information about the user at least in part to identify the one or more pieces of media that are associated with the one or more received characters.

11. The system of claim 1, wherein the matching component utilizes prior user selections of media at least in part to identify the one or more pieces of media that are associated with the one or more received characters.

12. The system of claim 1, wherein matching component utilizes prior pieces of media received by the user at least in part to identify the one or more pieces of media that are associated with the one or more received characters.

13. The system of claim 1, wherein the display component displays one or more pieces of media in an order related to the probability that the user will select a piece of media.

14. The system of claim 13, wherein the probability is based on prior actions of the user.

15. The system of claim 13, wherein the probability is based on prior actions of a group of users.

16. A method of modifying a character string entered by a user in a mobile device, the method comprising:
receiving a character string from a user of the mobile device; and
as each character in the character string is received:
identifying whether one or more pieces of media are associated with the received character string;
if one or more pieces of media are identified, displaying at least some of the identified one or more pieces of media to the user; and
allowing the user to select one of the displayed one or more pieces of media, wherein the received character string is replaced by the selected piece of media if the user selects one of the displayed one or more pieces of media.

17. The method of claim 16, wherein the received character string comprises a word.

18. The method of claim 16, wherein the received character string comprises a partial word.

19. The method of claim 16, wherein the received character string comprises two or more words.

20. The method of claim 16, wherein the mobile device has a reduced keyboard and the character string is input by the user using the reduced keyboard.

21. The method of claim 16, wherein the displayed one or more pieces of media comprise at least one icon.

22. The method of claim 16, wherein the displayed one or more pieces of media comprise at least one user-created image.

23. The method of claim 16, wherein the displayed one or more pieces of media comprise at least one graphic.

24. The method of claim 16, wherein the displayed one or more pieces of media comprise a link to a sound clip.

25. The method of claim 16, wherein the displayed one or more pieces of media comprise a link to a video clip.

26. The method of claim 16, wherein identifying whether one or more pieces of media are associated with the received character string depends at least in part on information pertaining to the context in which the character string was received.

27. The method of claim 16, wherein identifying whether one or more pieces of media are associated with the received character string depends at least in part on information about the user.

28. The method of claim 16, wherein identifying whether one or more pieces of media are associated with the received character string depends at least in part on prior user selections of pieces of media.

29. The method of claim 16, wherein identifying whether one or more pieces of media are associated with the received character string depends at least in part on prior pieces of media received by the user.

30. The method of claim 16, wherein the one or more pieces of media are displayed in an order related to the probability that the user will select a piece of media.

31. The method of claim 30, wherein the probability is based on prior actions of the user.

32. The method of claim 30, wherein the probability is based on prior actions of a group of users.

33. A computer-readable medium whose contents cause a computing system to perform a method of displaying a piece of media related to a string of characters, the method comprising:
receiving a string of characters from a user as part of a text message;
matching the received string of characters with at least two or more pieces of media;
displaying the matched two or more pieces of media to the user; and
allowing the user to select one of the matched two or more pieces of media, the selected piece of media to be inserted in place of the received string of characters in the text message.

34. The computer-readable medium of claim 33, further comprising:
inserting the selected piece of media in place of the string of characters in the text message.

35. The computer-readable medium of claim 33, wherein the received string of characters comprises a word.

36. The computer-readable medium of claim 33, wherein the received string of characters comprises a partial word.

37. The computer-readable medium of claim 33, wherein the received string of characters comprises two or more words.
